(19) United States
(12) Patent Application Publication
(10) Pub. No.: US 2006/0167982 A1
(43) Pub. Date: Jul. 27, 2006

(54) Restricted media sharing over networks

(75) Inventors: Amandeep Jawa, San Francisco, CA (US); Jeffrey L. Robbin, Los Altos, CA (US)

Correspondence Address: BEYER WEAVER & THOMAS LLP, P.O. BOX 70250, OAKLAND, CA, 94612-0250, US

(73) Assignee: Apple Computer, Inc.

(21) Appl. No.: 11/031,754

(22) Filed: Jan. 7, 2005

(51) Int. Cl. G06F 15/16

(52) U.S. Cl. 709/203

(57) ABSTRACT

Improved techniques to restrict sharing of media assets over a network are disclosed. A server computer having media assets can permit one or more clients to receive access to such media assets over a computer network. However, the access to such media assets can be restricted based on numerical limits as well as temporal limits. The media assets are digital media assets, such as audio items (e.g., audio files, including music or songs), videos (e.g., movies) or images (e.g., photos).

### BACKGROUND OF THE INVENTION

1. Field of the Invention

The present invention relates to media sharing and, more particularly, to management of media sharing across a network.

2. Description of the Related Art

A computer, referred to as a host computer, can serve to enable a user to manage, play and share media assets. As an example, the host computer can execute a media management application to manage, play and share media assets. One example of a media management application is iTunes®, version 4.2, produced by Apple Computer, Inc. Often, a media player can acquire its media assets from the host computer. The host computer can also enable a user to manage the media assets to be provided on the media player.

Conventionally, a media management application, such as iTunes®, has supported music sharing across networks. The music sharing by the media management application typically streams music from a host computer to one or more client computers that also operate a media management application, iTunes®. Hence, the music being streamed to the client computers is not intended to be stored on the client computers.

Hence, the stream-sharing feature available on certain media management applications, such as iTunes®, has been widely adopted inside companies and college campuses, which tend to have local area networks. Unfortunately, however, third-party solutions have extended the scope of music sharing by adding functionality to permit stream recording. Stream recording allows a client computer to store its own copy of the music being streamed from a host computer to the client computer. As a result, a client computer can copy a music collection stored on a host computer by way of streaming. In some cases, a digital rights management solution, e.g., using encryption, can prevent stream recordings from being usable at unauthorized client computers. Nevertheless, stream recording has lead to inappropriate and unauthorized copying of audio items, such as music.

Thus, there is a need for improved techniques to manage media sharing between different computers.

### SUMMARY OF THE INVENTION

Broadly speaking, the invention pertains to improved techniques to restrict sharing of media assets over a network. A server computer having media assets can permit one or more clients to receive access to such media assets over a computer network. However, the access to such media assets can be restricted based on numerical limits as well as temporal limits. The media assets are digital media assets, such as audio items (e.g., audio files, including music or songs), videos (e.g., movies) or images (e.g., photos).

The invention can be implemented in numerous ways, including as a method, system, device, apparatus (including graphical user interface), or computer readable medium. Several embodiments of the invention are discussed below.

As a method of managing sharing of media content from a server computer to one or more client computers across a computer network, one embodiment of the invention includes at least the acts of: receiving a connection request from a particular one of the client computers to receive media content from the server computer; determining whether at least one of a limited number of client slots is available for use by the particular client computer; assigning an available one of the client slots for use by the particular client computer when it is determined that at least one of a limited number of client slots is available for use by the particular client computer; establishing a connection for the particular client computer using the assigned client slot; determining when the connection for the particular client computer has ended or is to be ended; and reserving the assigned client slot for the particular client computer for at least a predetermined period of time after the connection for the particular client computer has ended.

As a method for restricted sharing of media content from a server computer to one or more client computers across a computer network, another embodiment of the invention includes at least the act of: receiving, from a particular one of the client computers, a login request to the server computer; obtaining a unique identifier associated with the particular client computer; determining whether any of a plurality of limited client slots are reserved for use by particular client computers; assigning the client slot to the particular client computer when it is determined that at least one of the limited client slots is reserved for the particular client computers; and granting the login request when the particular client device has been assigned one of the limited client slots.

As a computer readable medium including at least computer program code for managing sharing of media content from a server computer to one or more client computers across a computer network, one embodiment of the invention includes at least: computer program code for receiving a connection request from a particular one of the client computers to receive media content from the server computer; computer program code for determining whether at least one of a limited number of client slots is available for use by the particular client computer; computer program code for assigning an available one of the client slots for use by the particular client computer when the computer program code for determining determines that at least one of a limited number of client slots is available for use by the particular client computer; computer program code for establishing a connection for the particular client computer using the assigned client slot; computer program code for determining when the connection for the particular client computer has ended or is to be ended; and computer program code for reserving the assigned client slot for the particular client computer for at least a predetermined period of time after the connection for the particular client computer has ended.

As an electronic device, one embodiment of the invention includes at least: a network interface for coupling the electronic device to a computer network; a memory for storing media content; and a media management module operable to permit limited sharing of at least a portion of the media content stored in the memory to one or more other electronic devices coupled to the computer network. The media management module limits the sharing of at least a portion of the media content to a limited number of other electronic devices. Further, when one of the other electronic devices is permitted to participate in the sharing, the one of the other electronic devices is deemed to be sharing. When one of the other electronic devices has completed its participation in the sharing, the one of the other electronic devices is deemed to be reserved for sharing for at least a predetermined period of time, thereby restricting the sharing by different ones of the other electronic devices per unit time.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram of the media sharing system according to one embodiment of the invention.

FIG. 1B is a screen shot of a graphical user interface for configuring media sharing by a media management application.

FIG. 2 is a flow diagram of a media sharing process according to one embodiment of the invention.

FIGS. 3A and 3B are flow diagrams of a media sharing login process according to one embodiment of the invention.

FIG. 4 is a flow diagram of a media sharing logout process according to one embodiment of the invention.

FIG. 5 is a diagram of a reservation table according to one embodiment of the invention.

FIG. 6 is a block diagram of a media management system according to one embodiment of the invention.

### DETAILED DESCRIPTION OF THE INVENTION

The invention pertains to improved techniques to restrict sharing of media assets over a network. A server computer having media assets can permit one or more clients to receive access to such media assets over a computer network. However, the access to such media assets can be restricted based on numerical limits as well as temporal limits. The media assets are digital media assets, such as audio items (e.g., audio files, including music or songs), videos (e.g., movies) or images (e.g., photos).

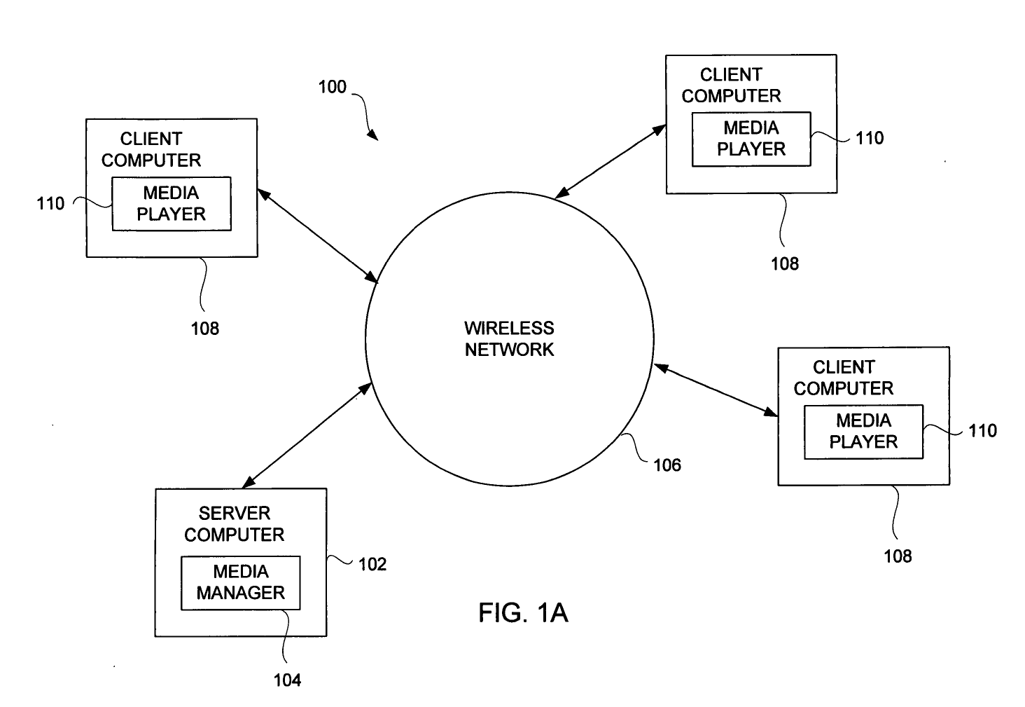

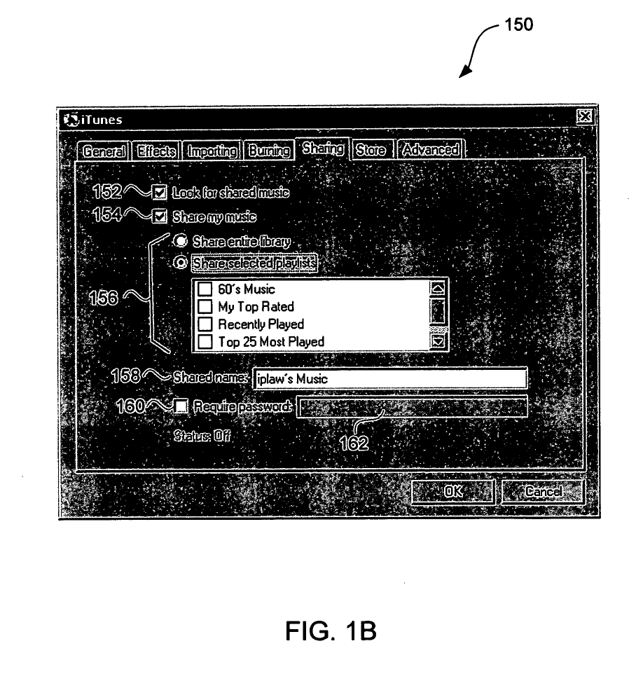

Embodiments of the invention are discussed below with reference to FIGS. 1A-6. However, those skilled in the art will readily appreciate that the detailed description given herein with respect to these figures is for explanatory purposes as the invention extends beyond these limited embodiments.

FIG. 1A is a block diagram of the media sharing system 100 according to one embodiment of the invention. The media sharing system 100 includes a server computer 102 that operates a media manager 104. The media manager 104, among other things, controls the sharing of media content that is stored on the server computer 102 with remote persons. The media content pertains to media assets, such as audio tracks. Typically, the media manager 104 can also perform other media management functions, such as assisting a user with organization of media content as well as locally playing the media content at the server computer 102. The server computer 102 can also couple to a computer network 106. In one embodiment, the computer network 106 can pertains to a Local Area Network (LAN). In other embodiments, the computer network 106 can pertain to a home network, a Wide Area Network (WAN), or the Internet.

In addition, the media sharing system 100 also includes one or more client computers 108. The client computers 108 can also couple to the computer network 106. Each of the client computers 108 includes a media player 110. The media player 110 within the client computer 110 is able to receive shared media content from the server computer 102 via the computer network 106. For example, in one implementation, the media player 108 receives shared media content that is streamed by the server computer 102 over the computer network 106 to one or more of the client computers 110. Typically, the media player 110 can also enable a user of the client computer 108 to manage and play media content stored locally.

In one embodiment, the media manager 104 is a media management application to manage, play and share media assets. One example of a media management application is iTunes®, version 4.2, produced by Apple Computer, Inc. In one embodiment, the media player 110 can receive shared media content via the computer network 106 and effect locally playing the shared media content, such as for the user of the client computer 110. The media player 110 can also store media assets, such as audio tracks or photos, that can be played or displayed on the media player 110.

According to one aspect of the invention, the media sharing system 100 can restrict the ability of the client computers 108 receive the shared media content from the server computer 102. In this regard, the restrictions can be interposed so that a user of the server computer 102 is encouraged to be more responsible in their sharing of media content across the computer network 106. For example, the user of the server computer 102 might be encouraged to impose passwords on those of the client computers 110 that desire to receive, and thus share, the shared media content being provided by the server computer 102. More particularly, in one embodiment, the restrictions can be such that only a limited number of the client computers 110 at any given point in time can receive the shared media content from the server computer 102 via the computer network 106. As an example, the restrictions could set the limited number of the client computers 110 to not exceed five (5), i.e., five slots.

Additionally, once a particular client computer 110 is permitted to receive the shared media content from the server computer 102, the particular client computer 110 is deemed to have taken a slot of the limited number of slots. Thereafter, when the particular client computer 110 no longer participates in the receiving of the shared media content from the server computer 102, the associated slot is no longer needed by the particular client computer 110 and could be released. However, instead of completely releasing the associated slot, the associated slot is deemed reserved for the particular client computer 110. For example, the associated slot can be deemed reserved for a predetermined reservation period (e.g., 24 hours). As a result, the ability for numerous anonymous client computers to participate in receiving shared media content from the server computer 102 is hindered because the turn-over rate of the limited number of slots is restricted.

FIG. 1B is a screen shot of a graphical user interface 150 for configuring media sharing by a media management application. The graphical user interface 150 provides a number of user interface controls that assists a user with configuring various media sharing operations. In this example, the media being shared is audio tracks or files, namely, music. A check box 152 configures the media management application to look for available shared music on a computer network, such as a local area network. The check box 154 allows a user of the media management application to enable music sharing of music stored on the present computer. The user interface controls 156 allow the user to specify whether all or some portion of the music stored on the present computer is to be shared, assuming that the check box 154 indicates that music is to be shared. Additionally, the graphical user interface 150 includes a text box 158 that allows in the user to specify a name for the shared music. Still further, the graphical user interface 150 includes a check box 162 and a text box 162 that are utilized to impose a password restriction on gaining access to the shared music.

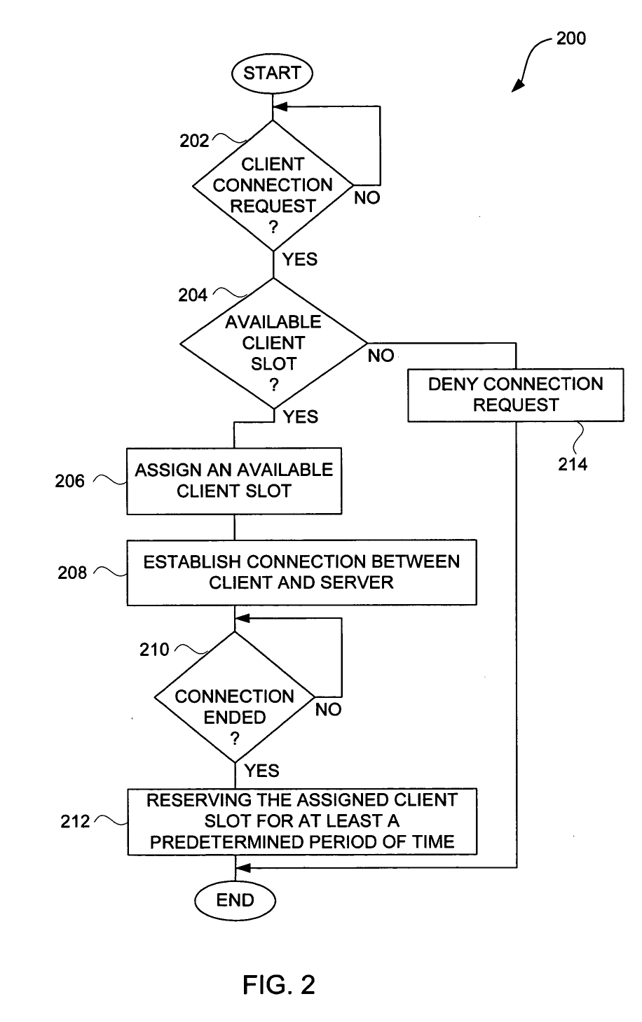

FIG. 2 is a flow diagram of a media sharing process 200 according to one embodiment of the invention. The media sharing processed 200 is, for example, performed by a server computer, such as the server computer 102 illustrated in FIG. 1A. In one example, the server computer 102 can be considered an audio server (e.g., music server).

The media sharing processed 200 begins with a decision 202 that determines whether a client connection request has been received. For example, a client connection request would be provided to the server computer by a client computer that desires to receive media content (i.e., shared media content) from the server computer. When the decision 202 determines that a client connection request has not been received, the media sharing processed 200 awaits such a request. On the other hand, once the decision 202 determines that a client connection request has been received, the media sharing processed 200 continues.

When the media sharing process 200 continues, a decision 204 determines whether there it is an available clients slot for the client computer that has requested connection with the server computer. The server computer only has a limited number of client slots for use by client computers that want to connect with the server computer to share media.

When the decision 204 determines that there is an available client slot, the available client slide is assigned 206 to the client computer. Next, a connection between the client computer and the server computer is established 208. Once the connection is established 208, the client computer is able to share media from the server computer. A decision 210 then determines whether the connection between the client computer and the server computer has ended. When the decision 210 determines that the connection between the client computer and the server computer has not ended, then the media sharing process 200 waits until the connection has ended. Here, the server computer can be doing other processing while it monitors for the connection to end. As an example, the media sharing process 210 can be implemented as a separate thread that is stalled until the established connection ends. In any case, once the decision 210 determines that the connection between client computer and the server computer has ended, the assigned client slot can be reserved 212 for at least a predetermined period of time. The predetermined period of time can also be referred to as a reservation period. During the predetermined period of time, only the client computer (should it again request connection with the server computer) can again use the client slot that is reserved. After the predetermined period of time, the client slot that has been reserved can be reused by any client computer properly seeking connection with the server computer to share media.

Alternatively, when the decision 204 determines that there is no available client slot for the client computer, then the connection request by the client computer is denied 214. Following the block 212 or the block 214, the media sharing process 200 is complete and ends.

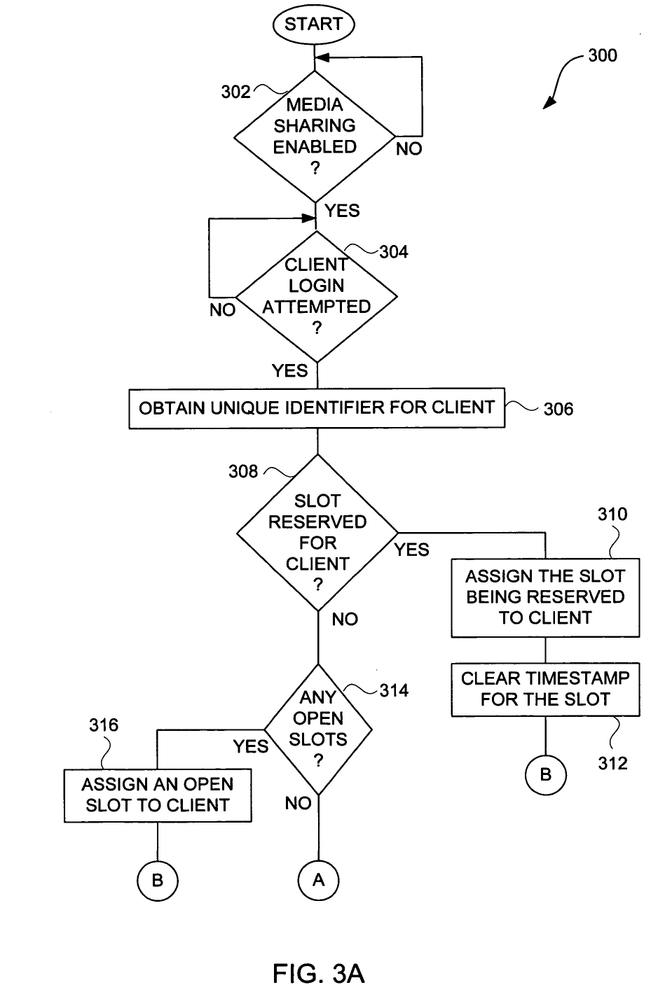

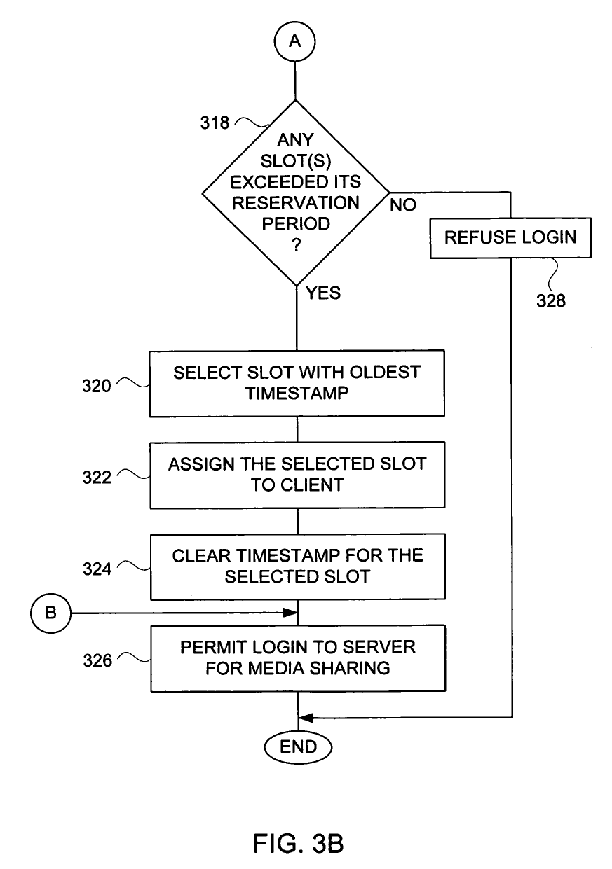

FIGS. 3A and 3B are flow diagrams of a media sharing login process 300 according to one embodiment of the invention. The media sharing login process 300 is processing performed to restrict sharing of media by a server computer. The media sharing login process 300 is, for example, performed by a server computer, such as the server computer 102 illustrated in FIG. 1A. The media being shared in accordance with the media sharing login process 300 is, for example, audio tracks (e.g., music or songs).

The media sharing login process 300 begins with a decision 302 that determines whether media sharing is enabled. Additionally, the server computer, or a user of the server computer, can have the ability to enable or disable the functionality regarding media sharing. When the decision 302 determines that music sharing is not enabled, then the media sharing login process 300 effectively is not invoked because media sharing is not permitted.

On the other hand, when the decision 302 determines that media sharing is enabled, a decision 304 determines whether a client login has been attempted. Here, a client computer (e.g., client) attempts to log into a server computer so as to access the shared media from the server computer (e.g., server) via a computer network. When the decision 304 determines that a client login has not been attempted, then the media sharing login process 300 awaits such a client login request.

Alternatively, once the decision 304 determines that a client login has been attempted, a unique identifier for the client is obtained 306. The unique identifier for the client can, for example, be associated with the client computer or a user of the client computer. Some examples of the unique identifier are: a Medium Access Control (MAC) address, an Internet Protocol (IP) address, a device identifier, GUID, a client identifier, or user name and/or password, or some combination thereof. A decision 308 then determines whether a slot is being reserved for the client. The slot pertains to one of a limited number of slots that are available to be utilized by clients. If a client previously used a slot offered by the server computer for sharing of music, the slot may still be reserved for that same client. Hence, when the decision 308 determines that a slot is reserved for the client, the slot being reserved for the client is assigned 310 to the client. In addition, a timestamp associated with the slot is cleared 312. Here, when a slot is reserved for a client, the slot is provided with a timestamp associated with its reservation, then when the slot that is reserved is subsequently reassigned to the client, the timestamp is cleared 312.

On the other hand, when the decision 308 determines that a slot is not reserved for the client, a decision 314 determines whether there are any open slots. Here, it should be noted that the number of slots available for clients seeking to access the server are limited. For example, the maximum number of slots might be five (5), in one example. Hence, when the decision 314 determines that there is an open slot, the open slot can be assigned 316 to the client.

In another alternative, when the decision 314 determines that there are no open slots for sharing media with the server, a decision 318 determines whether any of the slots have been reserved for more than a reservation period. The reservation period can be associated with a predetermined period of time (e.g., 24 hours). When the decision 318 determines that one or more of the slots have exceeded their reservation periods, a slot with the oldest timestamp is selected 320. The selected slot is then assigned 322 to the client. In one implementation, the assignment 322 of the selected slot can first be unreserved and then assigned. In addition, the timestamp associated with the selected slot is cleared 324.

Following the blocks 312, 316 or 326, the client login attempt has been successful because the client has been assigned one of the limited number of slots. Having been assigned a slot, the client is permitted to receive media (e.g., music or songs) being shared by the server. Hence, the login to the server for media sharing is permitted 326.

On the other hand, when the decision 318 determines that there are no slots that have exceeded their reservation period, the login attempt by the client is refused 328. Here, the login request is refused 328 because there are no available slots that can be assigned to the client. When there are no available slots, which are limited, the login attempt by the client is refused 328 and the client is unable to receive media being shared by the server. Following the blocks 326 or 328, the media sharing login process 300 is complete and ends.

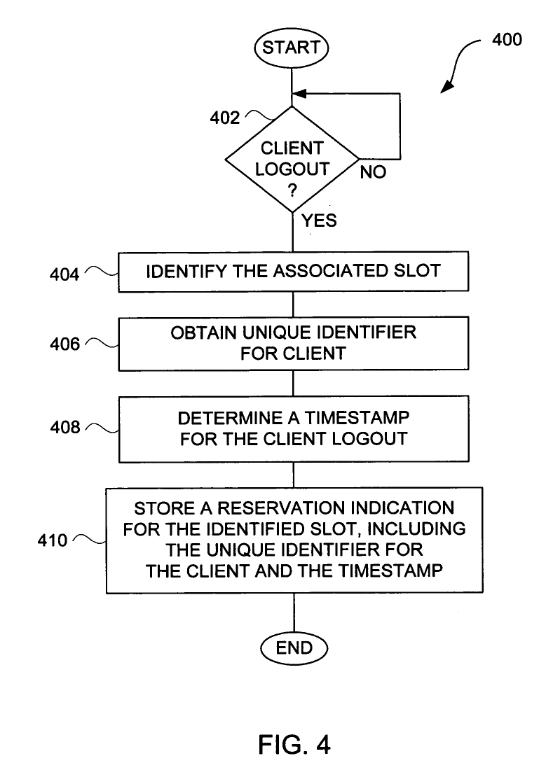

FIG. 4 is a flow diagram of a media sharing logout process 400 according to one embodiment of the invention. The media sharing logout processed 400 is, for example, performed by a server computer, such as the server computer 102 illustrated in FIG. 1A.

The media sharing logout process 400 begins with a decision 402 that determines whether a client logout is occurring, will soon occur or has recently occurred. Hereafter, for convenience, this condition is simply referred to as client logout being pending. When the decision 402 determines that a client logout is not pending, the media sharing logout process 400 awaits such a condition. In other words, the media sharing logout process 400 is effectively invoked once a client logout is pending.

Once the decision 402 determines that a client logout is pending, the associated slot to the client is identified 404. As noted above, when the login attempt was granted, the client was assigned a slot. Here, the slot that was then assigned is now identified 404. In addition, a unique identifier for the client is obtained 406. As noted above, the unique identifier for the client can take many different forms depending on implementation. A timestamp for the client logout is also determined 408. The timestamp can thus indicate the time the client logout occurred. Thereafter, a reservation indication is stored 410 for the identified slot. The reservation indication, for example, can include the unique identifier for the client as well as the timestamp for the client logout. Following the block 410, the media sharing logout process 400 is complete and ends.

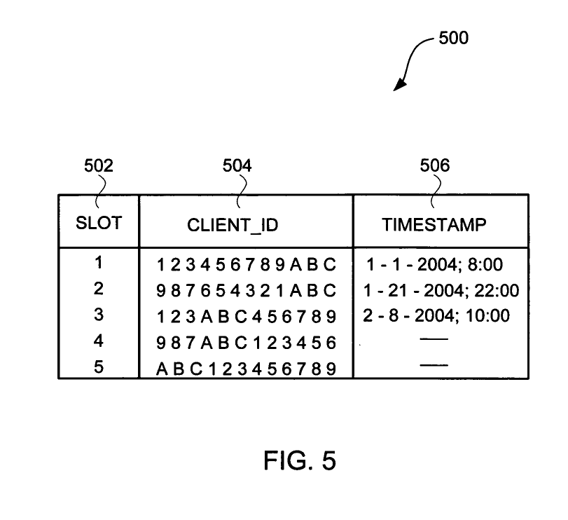

FIG. 5 is a diagram of a reservation table 500 according to one embodiment of the invention. The reservation table 500 represents one implementation of a storage mechanism that stores one or more reservation indications for associated slots of a given server computer. The reservation table 500 would typically be stored at the associated server computer. The reservation table 500 identifies and associates slots 502, client identifiers 504 and timestamps 506. As noted above, a server computer offers only a limited number of slots for media sharing with client computers. In the reservation table 500 there are only five (5) slots available. Slots 1, 2 and 3 are reserved for clients respectively identified by client identifiers (client_ID). Slots 1, 2 and 3 also include timestamps indicating when the reservations started. Slots 4 and 5 are currently assigned to clients respectively identified by client identifiers but do not have any timestamps.

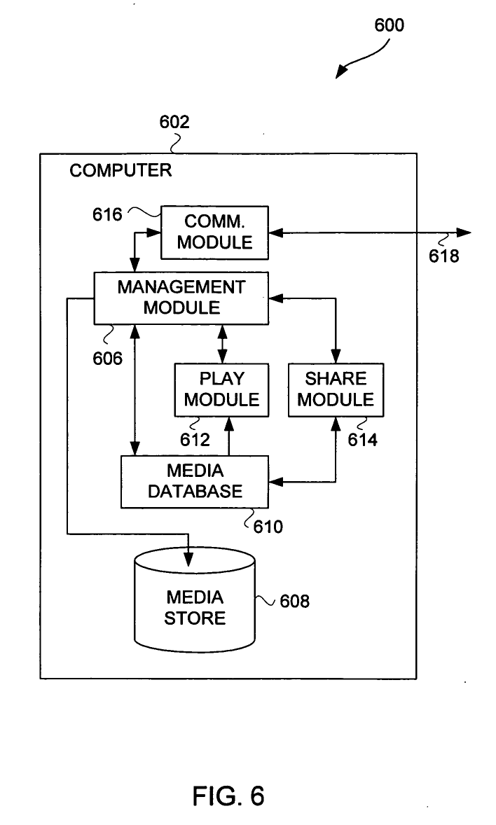

FIG. 6 is a block diagram of a media management system 600 according to one embodiment of the invention. The media management system 600 includes a computer 602. The computer 602 can pertain to a server computer or a client computer as previously discussed in other embodiments. The computer 602 is typically a personal computer. The computer 602, among other conventional components, includes a management module 606 which is a software module. The management module 606 provides for centralized management of media items (and/or playlists) on the computer 602. More particularly, the management module 606 manages those media items stored in a media store 608 associated with the computer 602. The management module 606 also interacts with a media database 610 to store media information associated with the media items stored in the media store 608.

The media information pertains to characteristics or attributes of the media items. For example, in the case of audio or audiovisual media, the media information can include one or more of: title, album, track, artist, composer and genre. These types of media information are specific to particular media items. In addition, the media information can pertain to quality characteristics of the media items. Examples of quality characteristics of media items can include one or more of: bit rate, sample rate, equalizer setting, volume adjustment, start/stop and total time.

Still further, the computer 602 includes a play module 612. The play module 612 is a software module that can be utilized to play certain media items stored in the media store 608. The play module 612 can also display (on a display screen) or otherwise utilize media information from the media database 610. Typically, the media information of interest corresponds to the media items to be played by the play module 612.

In addition, the computer 602 includes a share module 614 and a communication module 616. The share module 614 is used to support sharing of media items stored in the media store 608 with other computers over a computer network. The sharing can be implemented by streaming media content associated with one or more media items from the computer 602 to one or more other computers via the communication module 616. Typically, the share module 614 (alone or in combination with the management module 606) regulates or restricts the ability of media items to be shared with other computers. In one embodiment, the regulations or restrictions limit not only the number of other computers that can be sharing media items from the computer 602 at any point in time, but also the turn-over rate for the other computers. For example, if the maximum number of other computers permitted to share the media assets from the computer 602 is five (5) and the minimum turn-over duration is twenty-four (24) hours, then the ability for unfettered access by large numbers of other computers is effectively prevented.

The communication module 616 removeably couples to the computer network via a connection or link 618 so that data (including media items) can be transmitted to corresponding communication modules of other computers that are permitted to receive such data. In one embodiment, the connection or link 618 is a cable that provides a data bus, such as a FIREWIRE™ bus or USB bus, which is well known in the art. In another embodiment, the connection or link 618 is a wireless channel or connection through a wireless network. Hence, depending on implementation, the communication modules may communicate in a wired or wireless manner.

In one implementation, the computer 602 can utilize an application resident on the computer to permit utilization and provide management for media assets, including sharing of media assets. One such application is iTunes® produced by Apple Computer, Inc. of Cupertino, Calif.

The limited number of simultaneously shared clients (or client slots), namely five (5), and the reservation period, namely twenty-four (24) hours, noted above are exemplary parameters. Hence, it should be understood that these exemplary parameters are merely that, because various different values can be used depending on implementations and objectives.

Although the media items (or media assets) of emphasis in several of the above embodiments were audio items (e.g., audio files/tracks, including music or songs), the media items are not limited to audio items. For example, the media items can alternatively pertain to videos (e.g., movies) or images (e.g., photos).

Although the terms client computer and server computer are utilized above, these terms also include client and server, respectively. These terms include hardware, software, or hardware and software implementations.

The various aspects, embodiments, implementations or features of the invention can be used separately or in any combination.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that a media sharing in an open environment can be restricted. Another advantage of the invention is that restrictions on media sharing can discourage overuse of media sharing capabilities. Still another advantage of the invention is that responsible sharing of media across a network is encouraged. For example, media sharing restrictions can encourage users providing media sharing to impose a password requirement so that anonymous media sharing is largely prevented.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of managing sharing of media content from a server computer to one or more client computers across a computer network, said method comprising:
(a) receiving a connection request from a particular one of the client computers to receive media content from the server computer;
(b) determining whether at least one of a limited number of client slots is available for use by the particular client computer;
(c) assigning an available one of the client slots for use by the particular client computer when said determining (b) determines that at least one of a limited number of client slots is available for use by the particular client computer;
(d) establishing a connection for the particular client computer using the assigned client slot;
(e) determining when the connection for the particular client computer has ended or is to be ended; and
(f) reserving the assigned client slot for the particular client computer for at least a predetermined period of time after the connection for the particular client computer has ended.

2. A method as recited in claim 1, wherein, while connected using the assigned client slot, the particular client computer can receive media content being shared by the server computer over the computer network.

3. A method as recited in claim 2, wherein the computer network is a local area network.

4. A method as recited in claim 2, wherein the media content is being shared over the computer network by streaming the media content.

5. A method as recited in claim 1, wherein the client slots that are assigned or reserved are associated with particular client computers.

6. A method as recited in claim 1, wherein the particular client computer is distinguished from other client computers using a unique client identifier.

7. A method as recited in claim 1, wherein each of the clients slots are deemed available for use by the particular client computer when open or when reserved for the particular client computer.

8. A method as recited in claim 1, wherein said determining (b) making available a client slot that was previously reserved if the client slot has been reserved for more that the predetermined period of time.

9. A method as recited in claim 1, wherein the server computer is a personal computer operating as a music server, and wherein the one or more client computers are music clients.

10. A method for restricted sharing of media content from a server computer to one or more client computers across a computer network, said method comprising:
(a) receiving, from a particular one of the client computers, a login request to the server computer;
(b) obtaining a unique identifier associated with the particular client computer;
(c) determining whether any of a plurality of limited client slots are reserved for use by particular client computers;
(d) assigning the client slot to the particular client computer when said determining (c) determines that at least one of the limited client slots is reserved for the particular client computers; and
(e) granting the login request when the particular client device has been assigned one of the limited client slots.

11. A method as recited in claim 10, wherein said method further comprises:
(f) determining whether any of the limited client slots are unassigned to any of the client computers; and
(g) assigning the client slot to the particular client computer when said determining (f) determines that at least one of the limited client slots is unassigned to any of the client computers.

12. A method as recited in claim 11, wherein said assigning (g) operates to assign the client slot only if said assigning (d) does not assign the client slot.

13. A method as recited in claim 11, wherein said method further comprises:
(h) determining whether any of the limited client slots that are reserved for the particular client computers have been reserved for more than a predetermined reservation period; and
(i) assigning a client slot that has been reserved for more that the predetermined reservation period to the particular client computer when said determining (h) determines that at least one of the limited client slots has been reserved for more than the predetermined reservation period.

14. A method as recited in claim 13, wherein said assigning (i) operates to assign the client slot only if said assigning (d) and (g) do not assign the client slot.

15. A method as recited in claim 11, wherein said method further comprises:
(f) determining whether any of the limited client slots that are reserved for the particular client computers have been reserved for more than a predetermined reservation period; and
(g) assigning a client slot that has been reserved for more that the predetermined reservation period to the particular client computer when said determining (f) determines that at least one of the limited client slots has been reserved for more than the predetermined reservation period.

16. A method as recited in claim 15, wherein said assigning (g) operates to assign the client slot only if said assigning (d) does not assign the client slot.

17. A method as recited in claim 10, wherein said method further comprises: (f) determining when the particular client computer is logged out, has logged out or is about to be logged out; and
(g) reserving the assigned client slot for the particular client computer for at least a predetermined reservation period after the logout of the particular client computer.

18. A method as recited in claim 17, wherein said reserving (g) includes at least storing a reservation indication at the server computer for the assigned client slot, the reservation indication including at least a time indication and a unique identifier for the particular client computer.

19. A method as recited in claim 10, wherein the media content pertains to music, and
wherein the server computer is a personal computer operating as a music server, and wherein the one or more client computers are music clients.

20. A method as recited in claim 19, wherein the computer network is a local area network, wherein the media content is being shared over the computer network by streaming the media content.

21. A method as recited in claim 19, wherein the particular client computer is distinguished from other client computers using a unique client identifier.

22. A computer readable medium including at least computer program code for managing sharing of media content from a server computer to one or more client computers across a computer network, said computer readable medium comprising:
computer program code for receiving a connection request from a particular one of the client computers to receive media content from the server computer;
computer program code for determining whether at least one of a limited number of client slots is available for use by the particular client computer;
computer program code for assigning an available one of the client slots for use by the particular client computer when said computer program code for determining determines that at least one of a limited number of client slots is available for use by the particular client computer;
computer program code for establishing a connection for the particular client computer using the assigned client slot;
computer program code for determining when the connection for the particular client computer has ended or is to be ended; and
computer program code for reserving the assigned client slot for the particular client computer for at least a predetermined period of time after the connection for the particular client computer has ended.

23. A computer readable medium as recited in claim 22,
wherein, while connected using the assigned client slot, the particular client computer can receive media content being shared by the server computer over the computer network,
wherein the media content is being shared over the computer network by streaming the media content, and
wherein the computer network is a local area network.

24. An electronic device, comprising:
a network interface for coupling said electronic device to a computer network;
a memory for storing media content;
a media management module operable to permit limited sharing of at least a portion of the media content stored in said memory to one or more other electronic devices coupled to the computer network,
wherein said media management module limits the sharing of at least a portion of the media content to a limited number of other electronic devices,
wherein when one of the other electronic devices is permitted to participate in the sharing, the one of the other electronic devices is deemed to be sharing, and
wherein when one of the other electronic devices has completed its participation in the sharing, the one of the other electronic devices is deemed to be reserved for sharing for at least a predetermined period of time, thereby restricting the sharing by different ones of the other electronic devices per unit time.
